(19) United States
(12) Patent Application Publication
(10) Pub. No.: US 2008/0099382 A1
(43) Pub. Date: May 1, 2008

(54) Fluid filter device

(75) Inventor: Hui Chen Shih, Taichung (TW)

Correspondence Address: CHARLES E. BAXLEY, ESQ., 90 JOHN STREET, THIRD FLOOR, NEW YORK, NY, 10038, US

(73) Assignee: Len Yu Enterprise Co., Ltd.

(21) Appl. No.: 11/591,060

(22) Filed: Nov. 1, 2006

(51) Int. Cl. B01D 35/28

(52) U.S. Cl. 210/85; 210/445; 210/456; 210/223; 210/338; 96/1; 55/482; 55/490; 55/447

(57) ABSTRACT

A fluid filter device includes a container having a passage for a fluid to flow through the container, and having an inner peripheral chamber for receiving a filter medium which includes a bore communicating with the passage of the container, one or more guide members are disposed in the bore of the filter medium for stirring the fluid and for converting the fluid into an eddy flow. A filter screen is disposed and engaged with the filter medium for anchoring the filter medium. The filter medium includes a number of grooves for receiving particles or contaminants. One or more magnetic devices may be disposed in or on the container for attracting and collecting the metal particles or contaminants.

### BACKGROUND OF THE INVENTION

1. Field of the Invention

The present invention relates to a fluid filter device, and more particularly to a fluid filter device including an increased particle or contaminant receiving or storing space for preventing the fluid filter device from being quickly blocked and for suitably increasing the working life of the fluid filter device, and including a magnetic device for attracting and collecting the metal particles or contaminants and for further preventing the fluid filter device from being blocked by the metal particles or contaminants.

2. Description of the Prior Art

Various kinds of typical fluid filter devices have been developed and provided for attaching or mounting to an engine fuel system, an engine oil system, a water cooling system, a gearing oil lubricating system, an air conditioning system, or the like, and normally comprise a filter media received in a filter housing for fluid filtering purposes.

For example, U.S. Pat. No. 4,764,275 to Robichaud discloses one of the typical fluid filters also comprising a filter media received in a filter housing and positioned in the filter housing with one or more sets of circumferentially spaced projections or flanges.

However, the typical fluid filters are normally made of spongy materials that have no lateral orifices or spaces formed in the filter media for receiving or collecting the particles or contaminants such that the typical fluid filters will be quickly blocked or damaged by the particles or contaminants.

U.S. Pat. No. 4,851,117 to Foust discloses another typical filter device also comprising a fibrous folder media received in a filter housing and positioned in the filter housing with a coaxial tubular member which includes a number of openings formed therein.

However, similarly, the typical fluid filters are also normally made of spongy materials that have no lateral orifices or spaces formed in the fibrous folder media for receiving or collecting the particles or contaminants such that the typical fluid filters may also be quickly blocked or damaged by the collected particles or contaminants.

U.S. Pat. No. 5,076,918 to Foust et al. discloses a further typical oil filter device also comprising a filter medium received in a filter housing and positioned in the filter housing with an inner perforated sleeve which includes a number of openings formed therein.

However, similarly, the typical oil filter devices have no lateral orifices or spaces formed in the filter medium for receiving or collecting the particles or contaminants such that the typical fluid or oil filter devices may also be quickly blocked or damaged by the particles or contaminants.

U.S. Pat. No. 6,869,527 to Lu discloses a still further typical oil filter device also comprising one or more filter members and one or more filter housings received in a container for filtering purposes.

However, similarly, the typical oil filter devices are also made of spongy materials that have no lateral orifices or spaces formed in the filter members for receiving or collecting the particles or contaminants such that the typical fluid or oil filter devices may also be quickly blocked or damaged by the particles or contaminants. In addition, the typical oil or fluid filter devices have no magnetic devices for attracting and collecting the metal particles or contaminants.

The present invention has arisen to mitigate and/or obviate the afore-described disadvantages of the conventional fluid filter devices.

### SUMMARY OF THE INVENTION

The primary objective of the present invention is to provide a fluid filter device including an increased particle or contaminant receiving or storing space for preventing the fluid filter device from being quickly blocked and for suitably increasing the working life of the fluid filter device.

The other objective of the present invention is to provide a fluid filter device including a magnetic device for attracting and collecting the metal particles or contaminants and for preventing the fluid filter device from being blocked by the metal particles or contaminants.

In accordance with one aspect of the invention, there is provided a fluid filter device comprising a container including a passage formed therein for allowing a fluid to be filtered to flow through the container, and including an inner peripheral chamber formed therein, a filter medium disposed in the inner peripheral chamber of the container and including a bore formed therein and communicating with the passage of the container for allowing the fluid to flow through the bore of the filter medium and the passage of the outer container, and at least one guide member disposed in the bore of the filter medium for stirring the fluid and for converting the fluid into an eddy flow and thus for allowing the fluid to be effectively engaged with the filter medium and filtered by the filter medium.

The guide member is an annular guide member disposed in the bore of the filter medium and disposed or extended within the passage of the container and/or the bore of the filter medium for interfering or stirring the fluid. The filter medium includes a filter screen disposed in the bore of the filter medium and engaged with an inner peripheral portion of the filter medium for anchoring the filter medium within the inner peripheral chamber of the container, and the guide member is preferably engaged with the filter screen for further anchoring or positioning the filter medium within the inner peripheral chamber of the container.

The filter medium includes a number of grooves formed therein for receiving particles or contaminants. The filter medium includes a first filter layer and at least one second filter layer secured together. The first filter layer and the second filter layer include different thickness.

The container includes a peripheral swelling extended outwardly therefrom for forming the inner peripheral chamber thereof and for forming two reduced neck portions at two end portions of the container.

The container includes at least one magnetic device disposed therein. For example, the magnetic device may be engaged with one end of the filter medium, or engaged onto the outer peripheral portion of the container, or engaged around the outer peripheral portion of the container for attracting and collecting the metal particles or contaminants and for preventing the fluid filter device from being blocked or damaged by the metal particles or contaminants.

The container includes a detecting device engaged into the container for engaging with the fluid and for measuring or detecting the temperature of the fluid or oil and/or the pressure of the fluid or oil and/or the flowing speed or flowing quantity of the fluid or oil etc.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a fluid filter device in accordance with the present invention, in which one quarter of the fluid filter device has been cut off for showing an inner structure of the fluid filter device;

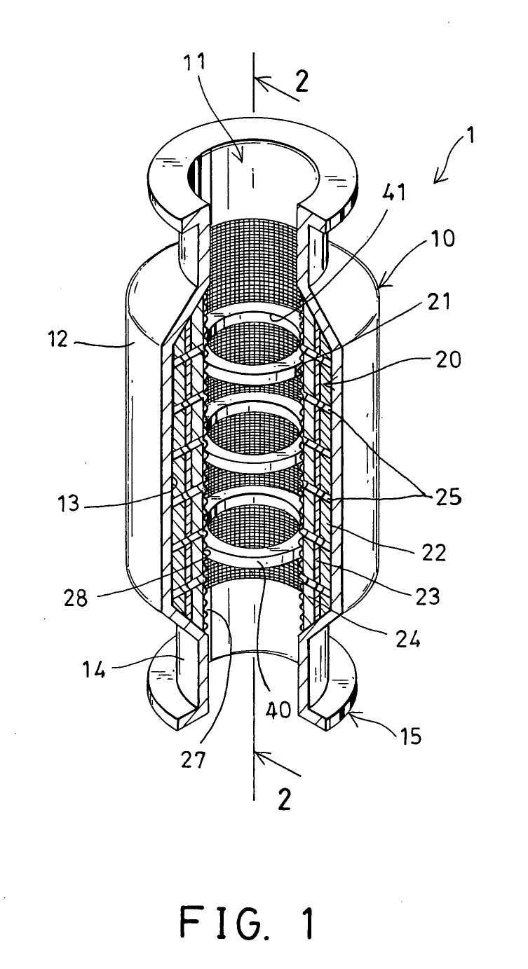

FIG. 2 is a cross sectional view of the fluid filter device taken along lines 2-2 of FIG. 1;

FIG. 3 is a cross sectional view similar to FIG. 2 illustrating the other arrangement of the fluid filter device;

FIG. 4 is a cross sectional view similar to FIGS. 2 and 3 illustrating the further arrangement of the fluid filter device;

FIG. 5 is a cross sectional view similar to FIGS. 2-4 illustrating the still further arrangement of the fluid filter device; and

FIG. 6 is a cross sectional view similar to FIGS. 2-5 illustrating the still further arrangement of the magnetic device for the fluid filter device.

### DETAILED DESCRIPTION OF THE PREFERRED EMBODIMENT

Referring to the drawings, and initially to FIG. a fluid filter device 1 in accordance with the present invention comprises an outer container 10 including a longitudinal passage 11 formed therein for allowing the fluid or oil to be filtered to flow through the outer container 10, and including a peripheral casing or swelling extended outwardly from the middle portion thereof for forming or defining an inner peripheral chamber 13 therein and for forming or defining two reduced neck portions 14 at two end portions 15 thereof.

The fluid filter device 1 further includes a cylindrical or tubular filter medium 20 disposed or engaged in the inner peripheral chamber 13 of the container 10, and having a bore 21 formed therein and aligned with or communicating with the passage 11 of the container 10 for allowing the fluid or oil to flow through both the bore 21 of the filter medium 20 and the passage 11 of the outer container 10. The filter medium 20 may include one or more filter layers 22, 23, 24, such as an outer filter layer 22, a middle or intermediate filter layer 23, and an inner filter layer 24 secured together.

It is preferable that the filter layers 22, 23, 24 include different width or thickness. For example, the middle or intermediate filter layer 23 may include width or thickness different or smaller than the other filter layers 23, 24, and may be made of filter materials different from that of the other filter layers 23, 24. The filter medium 20 includes a number of lateral grooves 25 formed therein for receiving or storing or collecting the particles or contaminants. A cylindrical or tubular filter screen 27 is further provided and disposed in the bore 21 of the filter medium 20 and engaged with the inner peripheral portion 28 of the filter medium 20 for stably anchoring and positioning the filter medium 20 within the inner peripheral chamber 13 of the container 10, and for allowing the fluid or oil to be filtered to flow through the filter screen 27 and then to flow into the lateral grooves 25 of the filter medium 20, and for allowing the particles or contaminants to be collected in the lateral grooves 25 of the filter medium 20.

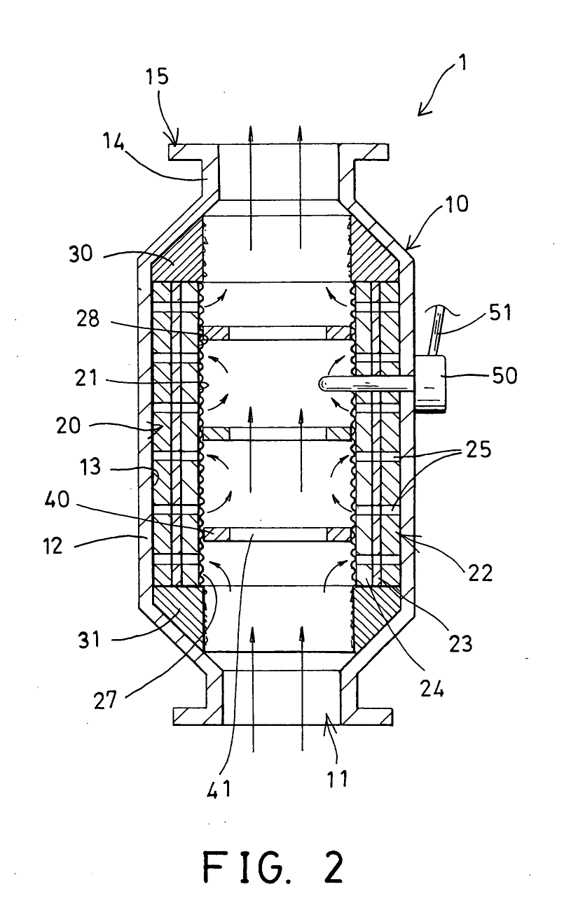

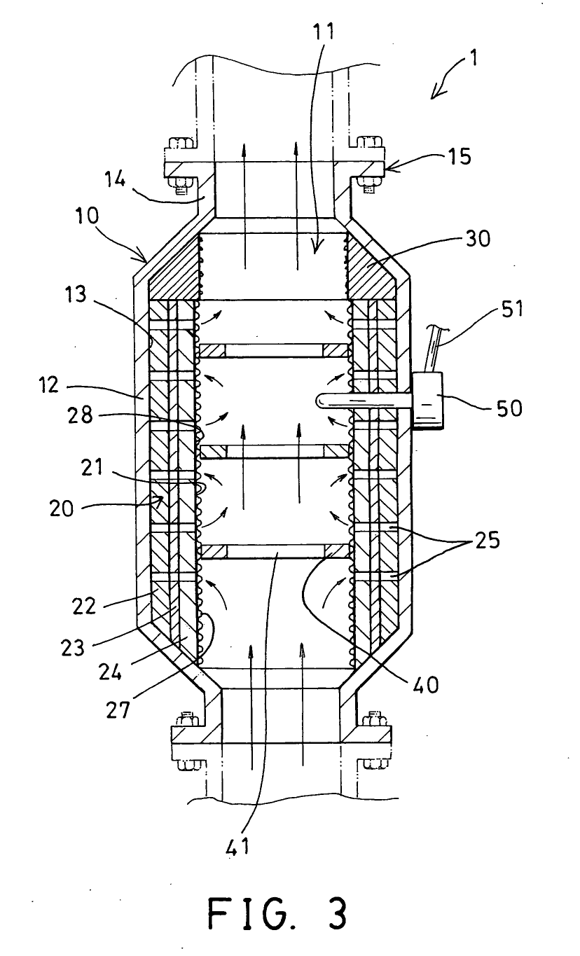

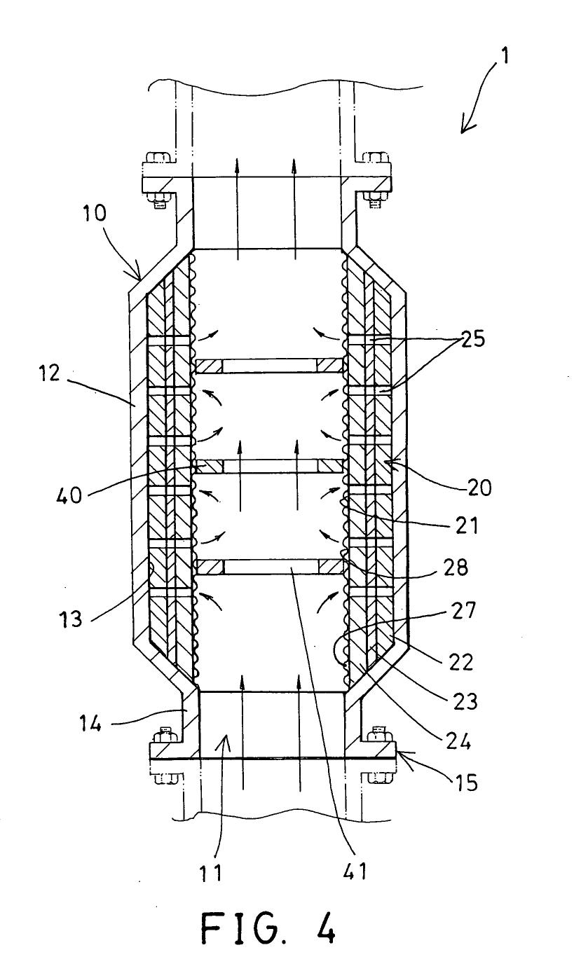

One or more magnetic members or devices 30, 31 may further be provided and engaged or disposed in the container 10, such as disposed in the inner peripheral chamber 13 of the container 10, and disposed or arranged above and/or below the filter medium 20 for attracting and collecting the metal particles or contaminants and for preventing the metal particles or contaminants from flow out through the container 10. For example, the container 10 may include two magnetic devices 30, 31 (FIG. 2), one magnetic device 30 (FIG. 3) for suitably attracting and collecting the metal particles or contaminants, or may include none magnetic devices (FIG. 4) therein.

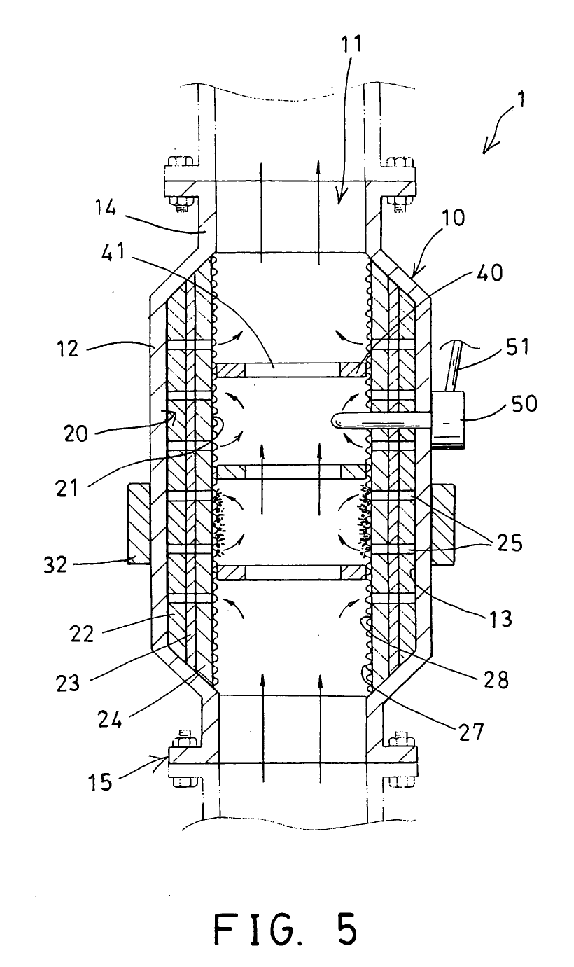

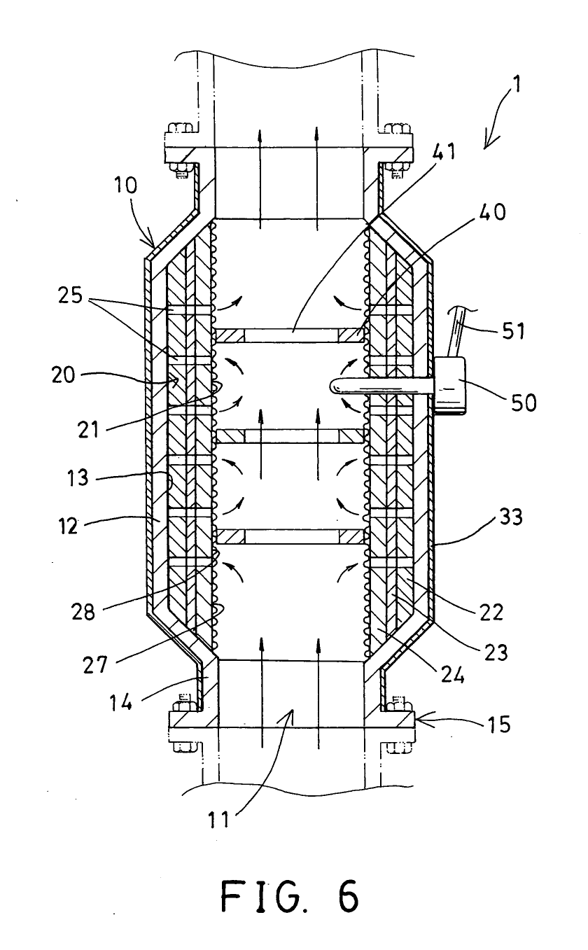

Alternatively, as shown in FIG. 5, an annular magnetic device 32 may be provided and engaged onto the outer peripheral portion of the container 10 for attracting and collecting the metal particles or contaminants. Further alternatively, as shown in FIG. 6, a magnetic outer covering 33 may further be provided and engaged onto the outer peripheral portion of the container 10 for attracting and collecting the metal particles or contaminants and also for preventing the metal particles or contaminants from flow out through the container 10.

The fluid filter device 1 may further includes one or more (such as three) annular guide members 40 disposed in the bore 21 of the filter medium 20 and engaged with the filter screen 27 for further anchoring and positioning the filter medium 20 within the inner peripheral chamber 13 of the container 10. The guide members 40 each include a space 41 formed therein and aligned with or communicating with the passage 11 of the container 10 and also communicating with the bore 21 of the filter medium 20 for allowing the fluid to flow through the bore 21 of the filter medium 20 and the spaces 41 of the guide members 40. The guide members 40 are disposed in the bore 21 of the filter medium 20 and may interfere or stir or agitate the fluid or oil and may convert the fluid or oil into an eddy current or an eddy flow and thus for facilitating the fluid or oil to flow into the lateral grooves 25 of the filter medium 20.

As shown in FIGS. 2-3 and 5-6, a detecting device 50 may further be provided and engaged into the container 10, and/or engaged through the filter medium 20 and/or the filter screen 27 for engaging with the fluid or the oil and for measuring or detecting the temperature of the fluid or oil and/or the pressure of the fluid or oil and/or the flowing speed or flowing quantity of the fluid or oil etc, and may be coupled to a processing device or a displayer (not shown) with a cable 51 for allowing the temperature and/or the pressure and/or the flowing speed or flowing quantity of the fluid or oil to be detected by the detecting device 50 and to be shown in the displayer (not shown).

It is to be noted that the typical fluid filter devices have no guide members 40 disposed in the bore 21 of the filter medium 20 for interfering or stirring the fluid or oil and for converting the fluid or oil into an eddy current or an eddy flow and thus for facilitating the fluid or oil to flow into the lateral grooves 25 of the filter medium 20.

Accordingly, the fluid filter device in accordance with the present invention includes an increased particle or contaminant receiving or storing space for preventing the fluid filter device from being quickly blocked and for suitably increasing the working life of the fluid filter device, and includes a magnetic device for attracting and collecting the metal particles or contaminants and for preventing the fluid filter device from being blocked by the metal particles or contaminants.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fluid filter device comprising:
a container including a passage formed therein for allowing a fluid to be filtered to flow through said container, and including an inner peripheral chamber formed therein,
a filter medium disposed in said inner peripheral chamber of said container and including a bore formed therein and communicating with said passage of said container for allowing the fluid to flow through said bore of said filter medium and said passage of said outer container, and
at least one guide member disposed in said bore of said filter medium for stirring the fluid and for converting the fluid into an eddy flow.

2. The fluid filter device as claimed in claim 1, wherein said at least one guide member is an annular guide member disposed in said bore of said filter medium.

3. The fluid filter device as claimed in claim 1, wherein said filter medium includes a filter screen disposed in said bore of said filter medium and engaged with an inner peripheral portion of said filter medium for anchoring said filter medium within said inner peripheral chamber of said container, and said at least one guide member is engaged with said filter screen.

4. The fluid filter device as claimed in claim 1, wherein said filter medium includes a plurality of grooves formed therein for receiving particles or contaminants.

5. The fluid filter device as claimed in claim 1, wherein said filter medium includes a first filter layer and at least one second filter layer.

6. The fluid filter device as claimed in claim 5, wherein said first filter layer and said at least one second filter layer include different thickness.

7. The fluid filter device as claimed in claim 1, wherein said container includes a peripheral swelling extended outwardly therefrom for forming said inner peripheral chamber thereof and for forming two reduced neck portions at two end portions of said container.

8. The fluid filter device as claimed in claim 1, wherein said container includes at least one magnetic device disposed therein.

9. The fluid filter device as claimed in claim 8, wherein said at least one magnetic device is engaged with one end of said filter medium.

10. The fluid filter device as claimed in claim 1, wherein said container includes a detecting device engaged into said container for engaging with the fluid.
